(19) United States
(12) Patent Application Publication
(10) Pub. No.: US 2019/0151994 A1
(43) Pub. Date: May 23, 2019

(54) Method and Apparatus for Performing Light Processing on Surface of Housing

(71) Applicant: Huawei Technologies Co., Ltd., Shenzhen (CN)

(72) Inventor: Renwei Guo, Shenzhen (CN)

(21) Appl. No.: 16/097,507

(22) PCT Filed: Jul. 8, 2016
(86) PCT No.: PCT/CN2016/089417

§ 371 Date: Oct. 29, 2018

(51) Int. Cl. B23K 26/364

(52) U.S. Cl. CPC B23K 26/364

(57) ABSTRACT

A method and an apparatus for performing light processing on a surface of a housing, where the method includes emitting, by a laser engraving machine, a first beam and a second beam, transmitting the first beam to a first bonding surface of the housing using a first light transmission region of a photomask to perform laser engraving on the first bonding surface, transmitting the second beam to a reflector using a second light transmission region of the photomask, and reflecting, by the reflector, the second beam to a second bonding surface of the housing to perform laser engraving on the second bonding surface, where there is an angle between the first bonding surface and the second bonding surface.

### TECHNICAL FIELD

The present invention relates to the field of surface processing technologies of a housing, and in particular, to a method and an apparatus for performing light processing on a surface of a housing in the field of surface processing technologies.

### BACKGROUND

Display screen falling-off is one of common problems in using a terminal device having a display screen. Strength of bonding force between a surface housing of the terminal device and the display screen is an important factor that determines quality of the terminal device. In a process of assembling the terminal device, roughness and a specific surface area of a housing of the terminal device are usually increased by performing surface processing on the housing of the terminal device, so that a bonding area of glue between the housing of the terminal device and the display screen is increased, and the housing of the terminal device and the display screen can be bonded more firmly by using the glue.

Performing laser engraving on the housing of the terminal device is an existing common means of performing surface processing on the housing of the terminal device. However, a light ray from a laser engraving machine used to perform surface processing on the housing of the terminal device is usually in a vertical direction, and it is relatively difficult to simultaneously perform laser engraving on a bottom face of the housing of the terminal device and a side face perpendicular to the bottom face.

### SUMMARY

The present invention provides a method and an apparatus for performing light processing on a surface of a housing, so as to simultaneously perform laser engraving on a bottom face and a side face of a housing of a terminal device.

According to a first aspect, the present invention provides a method for performing light processing on a surface of a housing, where the method includes:

emitting, by a laser engraving machine, a first beam and a second beam;

transmitting the first beam to a first bonding surface of the housing by using a first light transmission region of a photomask, so as to perform laser engraving on the first bonding surface;

transmitting the second beam to a reflection module by using a second light transmission region of the photomask; and

reflecting, by the reflection module, the second beam to a second bonding surface of the housing, so as to perform laser engraving on the second bonding surface, where there is an angle between the first bonding surface and the second bonding surface.

In the method for performing light processing on a surface of a housing provided in the present invention, the first beam emitted by the laser engraving machine is transmitted to the first bonding surface of the housing by using the first light transmission region of the photomask, so as to perform laser engraving on the first bonding surface. Therefore, a bonding area of the first bonding surface and glue can be increased, and bonding strength of the housing and a display screen can be improved.

In addition, in the method for performing light processing on a surface of a housing provided in the present invention, the second beam emitted by the laser engraving machine is transmitted to the reflection module by using the second light transmission region of the photomask, and the reflection module reflects the second beam to the second bonding surface, so as to perform laser engraving on the second bonding surface, where there is an angle between the first bonding surface and the second bonding surface. Therefore, laser engraving can be simultaneously performed on the first bonding surface and the second bonding surface of the housing, and the bonding strength of the housing and the display screen can be further improved.

With reference to the first aspect, in a first possible implementation of the first aspect, the reflection module includes a first reflection sheet and a second reflection sheet; and the reflecting, by the reflection module, the second beam to a second bonding surface of the housing, so as to perform laser engraving on the second bonding surface includes: reflecting, by the first reflection sheet, the second beam to the second reflection sheet; and reflecting, by the second reflection sheet, the second beam to the second bonding surface.

With reference to the first possible implementation of the first aspect, in a second possible implementation of the first aspect, an angle between the first reflection sheet and a vertical direction is 15° to 45°; or an angle between the second reflection sheet and the first reflection sheet is 125° to 145°.

In the method for performing light processing on a surface of a housing provided in the present invention, the second beam that is transmitted through the photomask is reflected to the second bonding surface of the housing by using the two reflection sheets, and an incident angle at which the second beam is reflected to the second bonding surface can be precisely controlled by controlling positions and angles of the first reflection sheet and the second reflection sheet, so that a surface shape of a laser engraving hole that is formed by performing laser engraving on the second bonding surface by using the second beam can be further controlled.

With reference to the first aspect, or the first or the second possible implementation of the first aspect, in a third possible implementation of the first aspect, the photomask includes N rows of light transmission holes that are in a direction parallel to an intersection line of the first bonding surface and the second bonding surface, the second light transmission region includes light transmission holes located in the first n rows, the first light transmission region includes light transmission holes located in the other (N−n) rows, N is an integer greater than or equal to 2, and n is an integer greater than or equal to 1.

With reference to the first aspect, or the first or the second possible implementation of the first aspect, in a fourth possible implementation of the first aspect, the photomask includes N rows of light transmission holes that are in a direction perpendicular to an intersection line of the first bonding surface and the second bonding surface, the second light transmission region includes n rows of light transmission holes, the first light transmission region includes (N−n) rows of light transmission holes, N is an integer greater than or equal to 2, and n is an integer greater than or equal to 1.

In the method for performing light processing on a surface of a housing provided in the present invention, laser engraving is performed on the housing by using a plurality of light transmission holes that are arranged differently on the photomask, so that laser engraving holes that are arranged differently can be obtained on the first bonding surface and the second bonding surface of the housing. This is applicable to a surface processing scenario in which there are different requirements on arrangements of laser engraving holes.

With reference to any one of the first aspect, or the first to the fourth possible implementations of the first aspect, in a fifth possible implementation of the first aspect, the first light transmission region includes at least one light transmission hole whose aperture is 0.1 μm to 3 mm; or the second light transmission region includes at least one light transmission hole whose aperture is 0.1 μm to 3 mm.

With reference to any one of the first aspect, or the first to the fifth possible implementations of the first aspect, in a sixth possible implementation of the first aspect, the first light transmission region includes at least one light transmission hole whose surface shape is a circle, a triangle, a square, or a parallelogram; or the second light transmission region includes at least one light transmission hole whose surface shape is a circle, a triangle, a square, or a parallelogram.

In the method for performing light processing on a surface of a housing provided in the present invention, an aperture and a surface shape of a laser engraving hole that is formed by performing laser engraving on the housing can be precisely controlled by controlling an aperture and a surface shape of a light transmission hole on the photomask. In addition, a hole depth of the laser engraving hole that is formed by performing laser engraving on the housing can be precisely controlled by controlling energy of a beam emitted by the laser engraving machine. Therefore, the method for performing light processing on a surface of a housing provided in the present invention is applicable to a development direction such as a narrower screen frame and a thinner terminal device body of a future terminal device.

With reference to any one of the first aspect, or the first to the sixth possible implementations of the first aspect, in a seventh possible implementation of the first aspect, the housing is a surface housing of a terminal device.

According to a second aspect, the present invention provides an apparatus for performing light processing on a surface of a housing, where the apparatus includes a photomask and a reflection module, the photomask includes a first light transmission region and a second light transmission region, and the reflection module is located below the photomask;

the first light transmission region is configured to transmit, to a first bonding surface of the housing, a first beam emitted by a laser engraving machine, so as to perform laser engraving on the first bonding surface;

the second light transmission region is configured to transmit, to the reflection module, a second beam emitted by the laser engraving machine; and

the reflection module is configured to reflect the second beam to a second bonding surface of the housing, so as to perform laser engraving on the second bonding surface, where there is an angle between the first bonding surface and the second bonding surface.

The apparatus for performing light processing on a surface of a housing provided in the present invention includes the photomask. The photomask includes a plurality of light transmission regions. The light transmission region is configured to transmit, to the first bonding surface of the housing, a beam emitted by the laser engraving machine, so as to perform laser engraving on the first bonding surface. Therefore, a bonding area of the first bonding surface and glue can be increased, and bonding strength of the housing and a display screen can be improved.

In addition, the apparatus further includes the reflection module, and the plurality of light transmission regions of the photomask include the first light transmission region and the second light transmission region. The reflection module is configured to reflect, to the second bonding surface, the second beam that is transmitted through the second light transmission region, so as to perform laser engraving on the second bonding surface, where there is an angle between the first bonding surface and the second bonding surface. Therefore, laser engraving can be simultaneously performed on the first bonding surface and the second bonding surface of the housing, and the bonding strength of the housing and the display screen can be further improved.

With reference to the second aspect, in a first possible implementation of the second aspect, the reflection module includes a first reflection sheet and a second reflection sheet; the first reflection sheet is configured to reflect the second beam to the second reflection sheet; and the second reflection sheet is configured to reflect, to the second bonding surface, the second beam reflected by the first reflection sheet.

With reference to the first possible implementation of the second aspect, in a second possible implementation of the second aspect, an angle between the first reflection sheet and a vertical direction is 15° to 45°; or an angle between the second reflection sheet and the first reflection sheet is 125° to 145°.

According to the apparatus for performing light processing on a surface of a housing provided in the present invention, the reflection module includes two reflection sheets. The two reflection sheets are configured to reflect, to the second bonding surface of the housing, the second beam that is transmitted through the second light transmission region, and an incident angle at which the second beam is reflected to the second bonding surface can be precisely controlled by disposing the two reflection sheets at different positions and angles, so that a surface shape of a laser engraving hole that is formed by performing laser engraving on the second bonding surface by using the second beam can be further controlled.

With reference to the second aspect, or the first or the second possible implementation of the second aspect, in a third possible implementation of the second aspect, the photomask includes N rows of light transmission holes that are in a direction parallel to an intersection line of the first bonding surface and the second bonding surface, the second light transmission region includes light transmission holes located in the first n rows, the first light transmission region includes light transmission holes located in the other (N−n) rows, N is an integer greater than or equal to 2, and n is an integer greater than or equal to 1.

With reference to the second aspect, or the first or the second possible implementation of the second aspect, in a fourth possible implementation of the second aspect, the photomask includes N rows of light transmission holes that are in a direction perpendicular to an intersection line of the first bonding surface and the second bonding surface, the second light transmission region includes n rows of light transmission holes, the first light transmission region includes (N−n) rows of light transmission holes, N is an integer greater than or equal to 2, and n is an integer greater than or equal to 1.

According to the apparatus for performing light processing on a surface of a housing provided in the present invention, the photomask includes a plurality of light transmission holes that are arranged differently. The plurality of light transmission holes that are arranged differently are configured to: after laser engraving is performed on the housing by using the photomask, obtain laser engraving holes that are arranged differently on the first bonding surface and the second bonding surface of the housing. This is applicable to a surface processing scenario in which there are different requirements on arrangements of laser engraving holes.

With reference to any one of the second aspect, or the first to the fourth possible implementations of the second aspect, in a fifth possible implementation of the second aspect, the first light transmission region includes at least one light transmission hole whose aperture is 0.1 μm to 3 mm; or the second light transmission region includes at least one light transmission hole whose aperture is 0.1 μm to 3 mm.

With reference to any one of the second aspect, or the first to the fifth possible implementations of the second aspect, in a sixth possible implementation of the second aspect, the first light transmission region includes at least one light transmission hole whose surface shape is a circle, a triangle, a square, or a parallelogram; or the second light transmission region includes at least one light transmission hole whose surface shape is a circle, a triangle, a square, or a parallelogram.

According to the apparatus for performing light processing on a surface of a housing provided in the present invention, the photomask includes a plurality of light transmission holes that have different apertures and surface shapes, so as to precisely control an aperture and a surface shape of a laser engraving hole that is formed by performing laser engraving on the housing. In addition, a hole depth of the laser engraving hole that is formed by performing laser engraving on the housing can be precisely controlled by controlling energy of a beam emitted by the laser engraving machine. Therefore, the apparatus for performing light processing on a surface of a housing provided in the present invention is suitable for performing laser engraving on a housing of a terminal device such as a future terminal device that has a narrower screen frame and a thinner terminal device body.

With reference to any one of the second aspect, or the first to the sixth possible implementations of the second aspect, in a seventh possible implementation of the second aspect, the housing is a surface housing of a terminal device.

### BRIEF DESCRIPTION OF DRAWINGS

To describe the technical solutions in the embodiments of the present invention more clearly, the following briefly describes the accompanying drawings required for describing the embodiments.

FIG. 1 is a schematic diagram of an apparatus for performing light processing on a surface of a housing according to an embodiment of the present invention;

FIG. 2 is a schematic diagram of another apparatus for performing light processing on a surface of a housing according to an embodiment of the present invention;

FIG. 3 is a schematic diagram of still another apparatus for performing light processing on a surface of a housing according to an embodiment of the present invention;

FIG. 4 is a schematic diagram of a light transmission hole according to an embodiment of the present invention;

FIG. 5 is a schematic diagram of a photomask according to an embodiment of the present invention;

FIG. 6 is a schematic diagram of another photomask according to an embodiment of the present invention;

FIG. 7 is a schematic flowchart of a method for performing light processing on a surface of a housing according to an embodiment of the present invention;

FIG. 8 is a schematic flowchart of another method for performing light processing on a surface of a housing according to an embodiment of the present invention;

FIG. 9 is a schematic flowchart of still another method for performing light processing on a surface of a housing according to an embodiment of the present invention; and

FIG. 10 is a schematic diagram of a surface housing of a terminal device according to an embodiment of the present invention.

### DESCRIPTION OF EMBODIMENTS

The following describes the technical solutions in the embodiments of the present invention with reference to the accompanying drawings in the embodiments of the present invention.

The technical solutions in the embodiments of the present invention may be applied to all terminal devices having a display screen. For example, the terminal device may be a mobile phone, a tablet personal computer (Tablet Personal Computer), a media player, a smart TV, a laptop computer (Laptop Computer), a personal digital assistant (personal digital assistant, PDA), a personal computer (Personal Computer), a mobile Internet device (Mobile Internet Device), or a wearable device (Wearable Device) such as a smartwatch that has a display screen. The technical solutions in the embodiments of the present invention may be further applied to a display device having a display screen. For example, the display device may be a television or a monitor. This is not limited in the embodiments of the present invention.

FIG. 1 shows a schematic diagram of an apparatus 100 for performing light processing on a surface of a housing according to an embodiment of the present invention.

It should be understood that the apparatus for performing light processing on a surface of a housing according to this embodiment of the present invention is configured to perform laser engraving processing on a bonding surface of a housing by using a laser beam emitted by a laser engraving machine, to form a laser engraving hole on the bonding surface of the housing, so as to perform glue dispensing on the to-be-bonded surface provided with the laser engraving hole, and bond the bonding surface with a display screen. However, this embodiment of the present invention is not limited thereto.

It should be further understood that the housing in this embodiment of the present invention may be a surface housing of a terminal device. The surface housing of the terminal device may include a bottom face (a first bonding surface) and a side face (a second bonding surface), and there is an angle between the bottom face and the side face.

Optionally, the terminal device may be a mobile phone, and the surface housing of the terminal device may be a surface housing of the mobile phone. In addition, a bottom face and a side face of the surface housing of the mobile phone are perpendicular to each other. However, this embodiment of the present invention is not limited thereto.

FIG. 1 may be a sectional view of the apparatus 100. The apparatus 100 includes a photomask 110 and a reflection module 120. The photomask 110 includes a light transmission region, and a region other than the light transmission region in the photomask 110 is a light shielding region 113.

Specifically, the light transmission region of the photomask 110 is configured to transmit, to a first bonding surface of the housing, some beams emitted by the laser engraving machine, so as to perform laser engraving on the first bonding surface. Remaining beams are shielded by the light shielding region 113.

The apparatus for performing light processing on a surface of a housing according to this embodiment of the present invention includes the photomask. The photomask includes the light transmission region. The light transmission region of the photomask is configured to transmit, to the first bonding surface of the housing, the beam emitted by the laser engraving machine, so as to perform laser engraving on the first bonding surface. Therefore, a bonding area of the first bonding surface and glue can be increased, and bonding strength of the housing and the display screen can be improved.

Specifically, the reflection module 120 is configured to reflect, to a second bonding surface of the housing, a beam that is transmitted from the light transmission region, so as to perform laser engraving on the second bonding surface. There is an angle between the first bonding surface and the second bonding surface.

The apparatus for performing light processing on a surface of a housing according to this embodiment of the present invention further includes the reflection module. The reflection module is configured to reflect, to the second bonding surface, the beam that is transmitted through the light transmission region, so as to perform laser engraving on the second bonding surface, where there is an angle between the first bonding surface and the second bonding surface.

Optionally, the photomask 110 and the reflection module 120 may be two separate apparatuses, or may be bonded by using a transparent medium and integrated into one apparatus. This is not limited in this embodiment of the present invention.

Specifically, the apparatus 100 may include the photomask 110 and the reflection module 120. The photomask 110 includes a first light transmission region and a second light transmission region. The first light transmission region is configured to transmit, to the first bonding surface of the housing, a first beam emitted by the laser engraving machine, so as to perform laser engraving on the first bonding surface. The second light transmission region is configured to transmit, to the reflection module, a second beam emitted by the laser engraving machine. The reflection module is configured to reflect the second beam to the second bonding surface of the housing, so as to perform laser engraving on the second bonding surface. There is an angle between the first bonding surface and the second bonding surface.

The apparatus for performing light processing on a surface of a housing according to this embodiment of the present invention can simultaneously perform laser engraving on the first bonding surface and the second bonding surface of the housing, so as to further increase the bonding strength of the housing and the display screen.

Optionally, the first light transmission region may include at least one light transmission hole (a light transmission hole 111 is shown in FIG. 1), and the second light transmission region may include at least one light transmission hole (a light transmission hole 112 is shown in FIG. 1). However, this is not limited in this embodiment of the present invention.

Optionally, the reflection module 120 may include a first reflection sheet 121 and a second reflection sheet 122. The first reflection sheet is configured to reflect, to the second reflection sheet, the second beam that is transmitted through the second light transmission region. The second reflection sheet is configured to reflect, to the second bonding surface of the housing, the second beam reflected by the first reflection sheet.

Optionally, an angle between the first reflection sheet and a vertical direction may be 15° to 45°, or an angle between the second reflection sheet and the first reflection sheet may be 125° to 145°. However, this is not limited in this embodiment of the present invention.

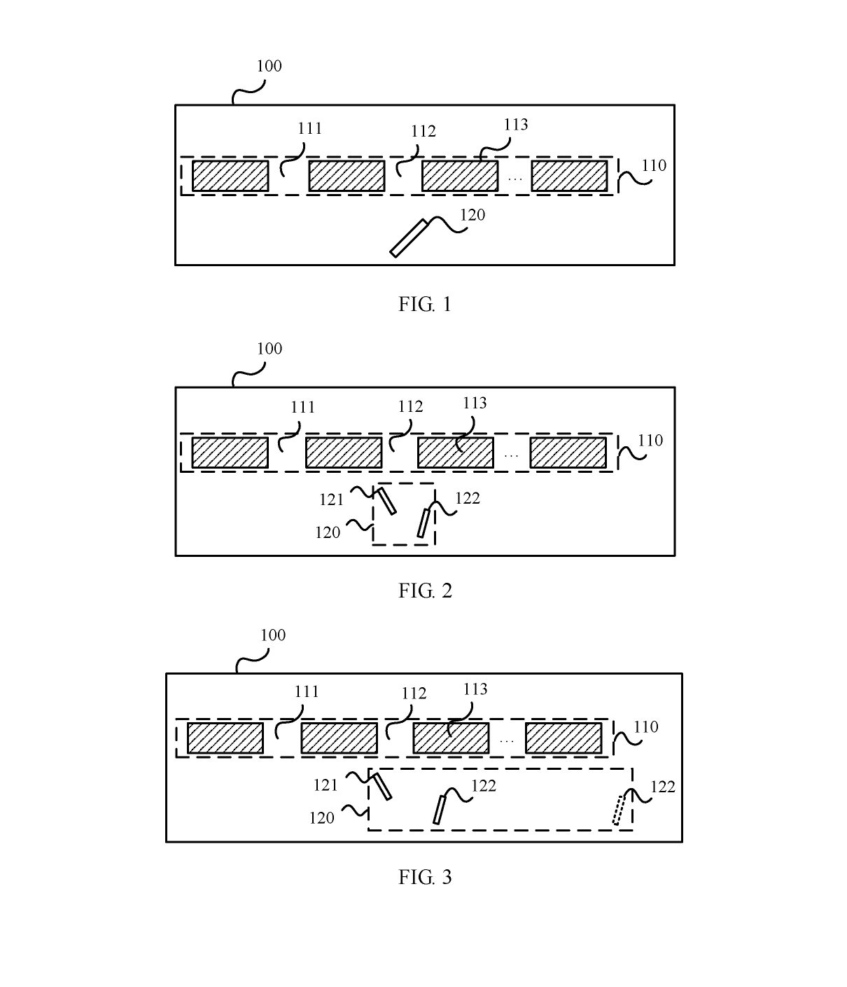

Optionally, as shown in FIG. 2, the first reflection sheet 121 and the second reflection sheet 122 may be located below the light transmission hole (for example, a light transmission hole 112 shown in FIG. 2) in the second light transmission region of the photomask, and the first reflection sheet is located between the photomask and the second reflection sheet, so as to reflect, to the second bonding surface, the second beam that is transmitted through the light transmission hole 112. However, this is not limited in this embodiment of the present invention.

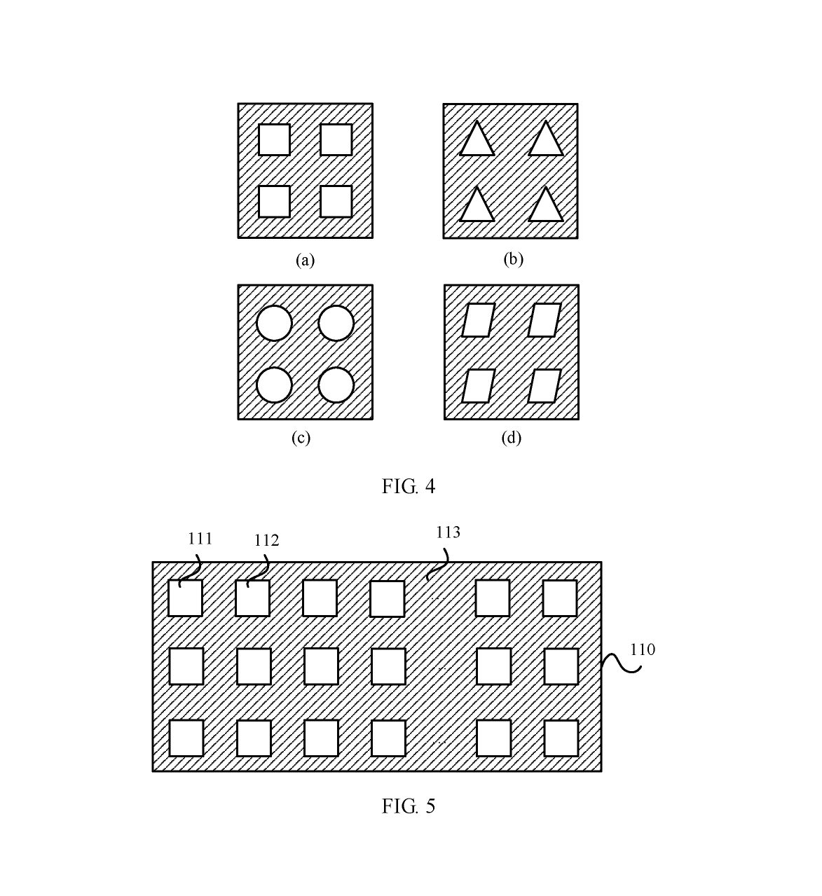

Optionally, as shown in FIG. 3, the first reflection sheet 121 may be located below the light transmission hole (for example, a light transmission hole 112 shown in FIG. 3) in the second light transmission region, and the second reflection sheet 122 (for example, a second reflection sheet 122 shown by using a solid line in FIG. 3) may be located below the light shielding region 113 of the photomask, or the second reflection sheet 122 (for example, a second reflection sheet 122 shown by using a dashed line in FIG. 3) may be located outside the photomask, so as to reflect, to the second bonding surface, the second beam that is transmitted through the light transmission hole 112. However, this is not limited in this embodiment of the present invention.

Optionally, the photomask 110, the first reflection sheet 121, and the second reflection sheet 122 may be used as separate apparatuses, and disposed between the laser engraving machine and the housing of the terminal device, or may be integrated into one apparatus by being bonded by using a transparent medium, and disposed between the laser engraving machine and the housing of the terminal device, so as to facilitate laser engraving performed by the laser engraving machine on the housing of the terminal device.

According to the apparatus for performing light processing on a surface of a housing in this embodiment of the present invention, an incident angle at which the second beam is reflected to the second bonding surface can be precisely controlled by disposing the two reflection sheets at different positions and angles, so that a surface shape of a laser engraving hole that is formed by performing laser engraving on the second bonding surface by using the second beam can be further controlled.

Optionally, the first light transmission region of the photomask may include at least one light transmission hole whose aperture is 0.1 μm to 3 mm, or the second light transmission region of the photomask includes at least one light transmission hole whose aperture is 0.1 μm to 3 mm. This is not limited in this embodiment of the present invention.

Optionally, as shown in FIG. 4, the first light transmission region of the photomask may include at least one light transmission hole whose surface shape is a square (as shown in (a) in FIG. 4), may include at least one light transmission hole whose surface shape is a triangle (as shown in (b) in FIG. 4), may include at least one light transmission hole whose surface shape is a circle (as shown in (c) in FIG. 4), or may include at least one light transmission hole whose surface shape is a parallelogram (as shown in (d) in FIG. 4). However, this is not limited in this embodiment of the present invention.

Optionally, as shown in FIG. 4, the second light transmission region of the photomask may include at least one light transmission hole whose surface shape is a square (as shown in (a) in FIG. 4), may include at least one light transmission hole whose surface shape is a triangle (as shown in (b) in FIG. 4), may include at least one light transmission hole whose surface shape is a circle (as shown in (c) in FIG. 4), or may include at least one light transmission hole whose surface shape is a parallelogram (as shown in (d) in FIG. 4). However, this is not limited in this embodiment of the present invention.

According to the apparatus for performing light processing on a surface of a housing in this embodiment of the present invention, the photomask includes a plurality of light transmission holes that have different apertures and surface shapes, so as to precisely control an aperture and a surface shape of a laser engraving hole that is formed by performing laser engraving on the housing. In addition, a hole depth of the laser engraving hole that is formed by performing laser engraving on the housing can be precisely controlled by controlling energy of a beam emitted by the laser engraving machine. Therefore, the apparatus for performing light processing on a surface of a housing provided in the present invention is suitable for performing laser engraving on a housing of a future terminal device that has a narrower screen frame and a thinner terminal device body.

In addition, a size and a shape of the light transmission hole on the photomask may be precisely controlled. Because a laser beam emitted by the laser engraving machine has extremely low divergence, granularities of a surface shape and a size of a laser engraving hole formed by performing laser engraving on a bonding surface by using a beam that is transmitted from the light transmission hole are finer and more precise than granularities of a shape and a size of a laser engraving hole formed by using an existing laser engraving technology.

FIG. 5 shows a schematic diagram of a photomask according to an embodiment of the present invention. The photomask includes N rows of light transmission holes (for example, N columns of light transmission holes shown in FIG. 5 from left to right) that are in a direction parallel to an intersection line of the first bonding surface and the second bonding surface of the housing. The second light transmission region includes light transmission holes located in the first n rows (for example, a column in which a light transmission hole 111 is located in FIG. 5). The first light transmission region includes light transmission holes located in the other (N−n) rows (for example, a column in which a light transmission hole 112 is located in FIG. 5), where N≥2, and n≥1.

In an optional embodiment, it is assumed that the second bonding surface of the housing is located on a left side of the photomask shown in FIG. 5. The light transmission hole (for example, the light transmission hole 112 shown in FIG. 5) included in the first region shown in FIG. 5 is configured to transmit the first beam to the first bonding surface, so as to perform laser engraving on the first bonding surface. The light transmission hole (for example, the light transmission hole 111 shown in FIG. 5) included in the second region is configured to transmit the second beam to the reflection module, and the second beam is reflected to the second bonding surface by using the reflection module, so as to perform laser engraving on the second bonding surface. Therefore, the first beam and the second beam do not interfere with each other during spatial propagation. However, this is not limited in this embodiment of the present invention.

Optionally, when laser engraving is performed on the housing by using the photomask shown in FIG. 5, the second light transmission region may include one or more columns of light transmission holes. When the second light transmission region includes a plurality of columns of light transmission holes, positions of reflection modules located below the columns of light transmission holes need to be mutually staggered in a vertical direction, so as to form laser engraving holes at different positions of the second bonding surface in the vertical direction. However, this is not limited in this embodiment of the present invention.

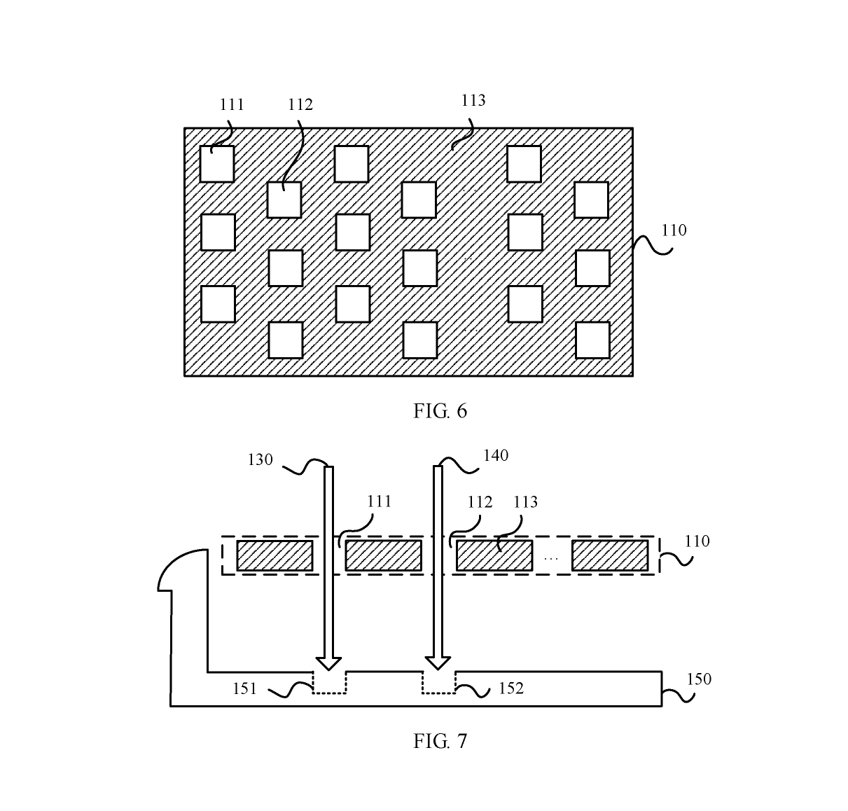

FIG. 6 shows a schematic diagram of another photomask according to an embodiment of the present invention. The photomask includes N rows of light transmission holes that are in a direction perpendicular to an intersection line of the first bonding surface and the second bonding surface. The second light transmission region includes n rows of light transmission holes. The first light transmission region includes (N−n) rows of light transmission holes, where N≥2, and n≥1.

In an optional embodiment, it is assumed that the second bonding surface of the housing is located on a left side of the photomask shown in FIG. 6. The light transmission hole (for example, a light transmission hole 111 shown in FIG. 6) included in the first region shown in FIG. 6 is configured to transmit the first beam to the first bonding surface, so as to perform laser engraving on the first bonding surface. The light transmission hole (for example, a light transmission hole 112 shown in FIG. 6) included in the second region is configured to transmit the second beam to the reflection module, and the second beam is reflected to the second bonding surface by using the reflection module, so as to perform laser engraving on the second bonding surface. Therefore, the first beam and the second beam do not interfere with each other during spatial propagation. However, this is not limited in this embodiment of the present invention.

Optionally, the light transmission hole (for example, the light transmission hole 111 shown in FIG. 6) included in the first light transmission region shown in FIG. 6 and the light transmission hole (for example, the light transmission hole 112 shown in FIG. 6) included in the second light transmission region may be alternatively located in a same column, and the light transmission hole in the first region and the light transmission hole in the second region that are located in the same column are arranged in a totally staggered manner and do not overlap. However, this is not limited in this embodiment of the present invention.

Optionally, when laser engraving is performed on the housing by using the photomask shown in FIG. 6, the second light transmission region may include one or more columns of light transmission holes. When the second light transmission region includes a plurality of columns of light transmission holes, positions of reflection modules located below the columns of light transmission holes need to be mutually staggered in a vertical direction, so as to form laser engraving holes at different positions of the second bonding surface in the vertical direction. However, this is not limited in this embodiment of the present invention.

According to the apparatus for performing light processing on a surface of a housing in this embodiment of the present invention, the photomask includes a plurality of light transmission holes that are arranged differently. The plurality of light transmission holes that are arranged differently are configured to: after laser engraving is performed on the housing by using the photomask, obtain laser engraving holes that are arranged differently on the first bonding surface and the second bonding surface of the housing. This is applicable to a surface processing scenario in which there are different requirements on arrangements of laser engraving holes.

The foregoing describes the apparatus for performing light processing on a surface of a housing according to the embodiments of the present invention with reference to FIG. 1 to FIG. 6. The following describes in detail a method for performing light processing on a surface of a housing according to the embodiments of the present invention with reference to FIG. 7 to FIG. 10.

FIG. 7 shows a schematic flowchart of a method for performing light processing on a surface of a housing according to an embodiment of the present invention. The method may be used to perform laser engraving on a surface housing of a terminal device, and is executed by a laser engraving machine. However, this is not limited in this embodiment of the present invention.

Specifically, the laser engraving machine emits at least one beam. Each of the at least one beam is transmitted, by using a light transmission hole in a light transmission region of a photomask 110, to a first bonding surface of a housing that is located below the photomask, so as to form a laser engraving hole on the first bonding surface.

In an optional embodiment, as shown in FIG. 7, the laser engraving machine emits a first beam 130 and a second beam 140. The first beam 130 is transmitted to a first bonding surface 150 of the housing by using a light transmission hole 111 on the photomask, so as to form a laser engraving hole 151 on the first bonding surface. The second beam 140 is transmitted to the first bonding surface 150 by using a light transmission hole 112 on the photomask, so as to form a laser engraving hole 152 on the first bonding surface.

In the method for performing light processing on a surface of a housing according to this embodiment of the present invention, the first beam emitted by the laser engraving machine is transmitted to the first bonding surface of the housing by using a first light transmission region of the photomask, so as to perform laser engraving on the first bonding surface. Therefore, a bonding area of the first bonding surface and glue can be increased, and bonding strength of the housing and a display screen can be improved.

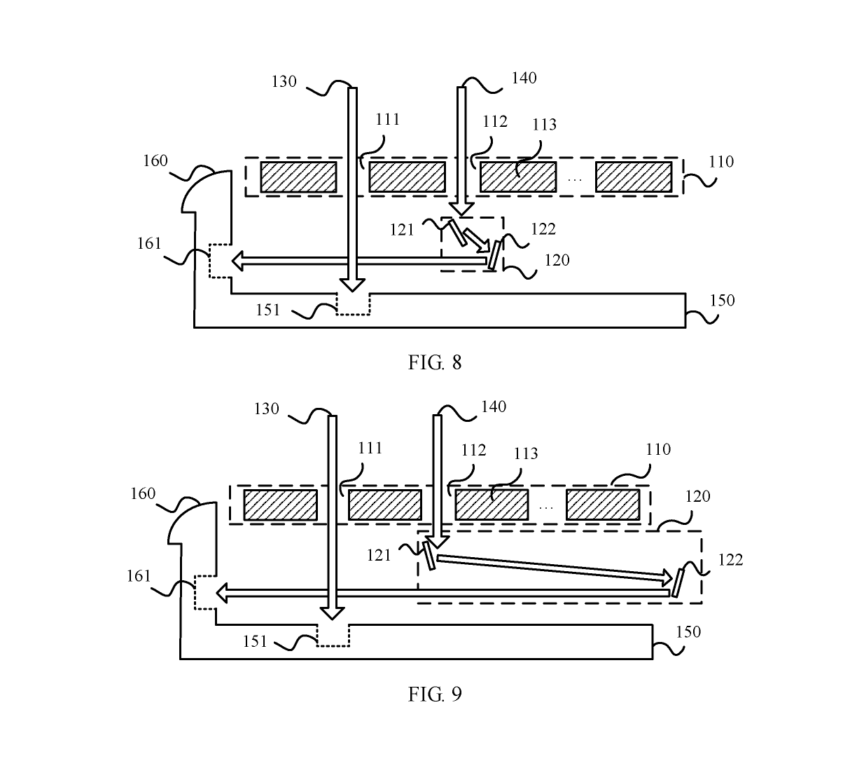

FIG. 8 shows a schematic flowchart of another method for performing light processing on a surface of a housing according to an embodiment of the present invention. The method may be used to perform laser engraving on a surface housing of a terminal device, and is executed by a laser engraving machine. However, this is not limited in this embodiment of the present invention.

Specifically, the laser engraving machine emits a first beam and a second beam. The first beam is transmitted to a first bonding surface of a housing by using a first light transmission region of a photomask, so as to form a laser engraving hole on the first bonding surface. The second beam is transmitted to a second bonding surface of the housing by using a second light transmission region of the photomask, so as to form a laser engraving hole on the second bonding surface.

In an optional embodiment, as shown in FIG. 8, the laser engraving machine emits a first beam 130 and a second beam 140. The first beam 130 is transmitted to a first bonding surface 150 of the housing by using a light transmission hole 111 on the photomask, so as to form a laser engraving hole 151 on the first bonding surface. The second beam 140 is transmitted to a reflection module 120 by using a light transmission hole 112 on the photomask, and the second beam 140 is reflected to a second bonding surface 160 of the housing by using the reflection module 120, so as to form a laser engraving hole 161 on the second bonding surface.

In the method for performing light processing on a surface of a housing according to this embodiment of the present invention, the second beam emitted by the laser engraving machine is transmitted to the reflection module by using the second light transmission region of the photomask, and the reflection module reflects the second beam to the second bonding surface, so as to perform laser engraving on the second bonding surface, where there is an angle between the first bonding surface and the second bonding surface. Therefore, laser engraving can be simultaneously performed on the first bonding surface and the second bonding surface of the housing, and bonding strength of the housing and a display screen can be further improved.

Optionally, the reflection module 120 may include a first reflection sheet 121 and a second reflection sheet 122. The second beam is transmitted to the first reflection sheet 121 by using the light transmission hole 112, is reflected to the second reflection sheet 122 by using the first reflection sheet 121, and is reflected to the second bonding surface 160 of the housing by using the second reflection sheet 122, so as to form the laser engraving hole 161 on the second bonding surface. However, this is not limited in this embodiment of the present invention.

Optionally, as shown in FIG. 8, the first reflection sheet 121 and the second reflection sheet 122 may be located below a light transmission hole (for example, the light transmission hole 112 shown in FIG. 8) in the second light transmission region of the photomask, and the first reflection sheet is located between the photomask and the second reflection sheet, so as to reflect, to the second bonding surface for laser engraving, the second beam that is transmitted through the light transmission hole 112. However, this is not limited in this embodiment of the present invention.

Optionally, as shown in FIG. 9, the first reflection sheet 121 may be located below a light transmission hole (for example, a light transmission hole 112 shown in FIG. 9) in the second light transmission region, and the second reflection sheet 122 (for example, a second reflection sheet 122 shown in FIG. 3) may be located outside the photomask, so as to reflect, to the second bonding surface for laser engraving, the second beam that is transmitted through the light transmission hole 112. However, this is not limited in this embodiment of the present invention.

Optionally, the photomask 110, the first reflection sheet 121, and the second reflection sheet 122 may be used as separate apparatuses, and disposed between the laser engraving machine and the housing of the terminal device, or may be integrated into one apparatus by being bonded by using a transparent medium, and disposed between the laser engraving machine and the housing of the terminal device, so as to facilitate laser engraving performed by the laser engraving machine on the housing of the terminal device.

Optionally, an angle between the first reflection sheet and a vertical direction is 15° to 45°, or an angle between the second reflection sheet and the first reflection sheet is 125° to 145°.

For example, it is assumed that the first bonding surface of the housing is perpendicular to the second bonding surface, the angle between the first reflection sheet and the vertical direction is 22.5°, and the angle between the second reflection sheet and the first reflection sheet is 135°. Therefore, the second beam can be reflected to the second bonding surface along a horizontally leftward direction through reflection from the first reflection sheet and the second reflection sheet.

In the method for performing light processing on a surface of a housing according to this embodiment of the present invention, the second beam that is transmitted through the photomask is reflected to the second bonding surface of the housing by using the two reflection sheets, and an incident angle at which the second beam is reflected to the second bonding surface can be precisely controlled by controlling positions and angles of the first reflection sheet and the second reflection sheet, so that a surface shape of a laser engraving hole that is formed by performing laser engraving on the second bonding surface by using the second beam can be further controlled.

Optionally, the first light transmission region of the photomask may include at least one light transmission hole whose aperture is 0.1 μm to 3 mm, or the second light transmission region of the photomask includes at least one light transmission hole whose aperture is 0.1 μm to 3 mm. This is not limited in this embodiment of the present invention.

Optionally, the first light transmission region of the photomask may include at least one light transmission hole whose surface shape is a square (as shown in (a) in FIG. 4), may include at least one light transmission hole whose surface shape is a triangle (as shown in (b) in FIG. 4), may include at least one light transmission hole whose surface shape is a circle (as shown in (c) in FIG. 4), or may include at least one light transmission hole whose surface shape is a parallelogram (as shown in (d) in FIG. 4). However, this is not limited in this embodiment of the present invention.

Optionally, the second light transmission region of the photomask may include at least one light transmission hole whose surface shape is a square (as shown in (a) in FIG. 4), may include at least one light transmission hole whose surface shape is a triangle (as shown in (b) in FIG. 4), may include at least one light transmission hole whose surface shape is a circle (as shown in (c) in FIG. 4), or may include at least one light transmission hole whose surface shape is a parallelogram (as shown in (d) in FIG. 4). However, this is not limited in this embodiment of the present invention.

In the method for performing light processing on a surface of a housing according to this embodiment of the present invention, an aperture and a surface shape of a laser engraving hole that is formed by performing laser engraving on the housing can be precisely controlled by controlling an aperture and a surface shape of a light transmission hole on the photomask. In addition, a hole depth of the laser engraving hole that is formed by performing laser engraving on the housing can be precisely controlled by controlling energy of a beam emitted by the laser engraving machine. Therefore, the method for performing light processing on a surface of a housing provided in the present invention is applicable to a development direction such as a narrower screen frame and a thinner terminal device body of a future terminal device.

In addition, a size and a shape of the light transmission hole on the photomask may be precisely controlled. Because a laser beam emitted by the laser engraving machine has extremely low divergence, granularities of a surface shape and a size of a laser engraving hole formed by performing laser engraving on a bonding surface by using a beam that is transmitted from the light transmission hole are finer and more precise than granularities of a shape and a size of a laser engraving hole formed by using an existing laser engraving technology.

In the method for performing light processing on a surface of a housing according to this embodiment of the present invention, a plurality of light transmission holes in different arrangement manners shown in FIG. 5 and FIG. 6 can be disposed on the photomask, and laser engraving is performed on the housing by using these light transmission holes, so that laser engraving holes that are arranged differently can be obtained on the first bonding surface and the second bonding surface of the housing. This is applicable to a surface processing scenario in which there are different requirements on arrangements of laser engraving holes.

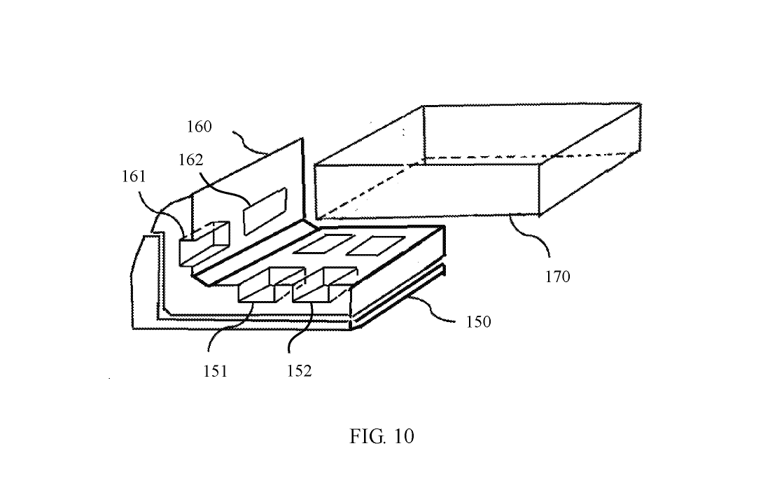

FIG. 10 shows a schematic diagram of a surface housing of a terminal device according to an embodiment of the present invention. For example, the surface housing of the terminal device is a surface housing of a mobile phone. As shown in FIG. 10, after laser engraving is performed on the surface housing of the terminal device by using the apparatus for performing light processing on a surface of a housing that is shown in FIG. 2 or FIG. 3 and the method for performing light processing on a surface of a housing that is shown in FIG. 8 or FIG. 9, laser engraving holes (a laser engraving hole 151 and a laser engraving hole 152 are shown in FIG. 10) on a bottom face 150 of the surface housing of the mobile phone that is shown in FIG. 10 and laser engraving holes (a laser engraving hole 161 and a laser engraving hole 162 are shown in FIG. 10) on a side face 160 of the surface housing of the mobile phone may be formed. After glue dispensing is performed on the bottom face and the side face of the surface housing of the mobile phone, the bottom face and the side face may be bonded to a display screen 170 of the mobile phone.

According to the method and the apparatus for performing light processing on a surface of a housing provided in the present invention, laser engraving can be simultaneously performed on the bottom face and the side face of the surface housing of the mobile phone, and surface shapes and apertures of laser engraving holes that are formed by performing laser engraving can be precisely controlled. Therefore, a bonding area of the surface housing of the mobile phone and glue can be increased, and bonding strength of the glue between the surface housing of the mobile phone and the display screen can be increased.

According to the apparatus for performing light processing on a surface of a housing provided in the present invention, the photomask includes a plurality of light transmission holes that are arranged differently. The plurality of light transmission holes that are arranged differently are configured to: after laser engraving is performed on the housing by using the photomask, obtain laser engraving holes that are arranged differently on the bottom face and the side face of the surface housing of the mobile phone. This is applicable to a surface processing scenario in which there are different requirements on arrangements of laser engraving holes.

The method for performing light processing on a surface of a housing provided in the present invention is applicable to a development direction such as a narrower screen frame and a thinner body of a future mobile phone.

In addition, a size and a shape of the light transmission hole on the photomask may be precisely controlled. Because a laser beam emitted by the laser engraving machine has extremely low divergence, granularities of a surface shape and a size of a laser engraving hole formed by performing laser engraving on the surface housing of the mobile phone by using a beam that is transmitted from the light transmission hole are finer and more precise than granularities of a shape and a size of a laser engraving hole formed by using an existing laser engraving technology.

In an implementation process, steps in the foregoing methods can be implemented by using a hardware integrated logical circuit in the processor, or by using instructions in a form of software. The steps of the method disclosed with reference to the embodiments of the present invention may be directly performed by a hardware processor, or may be performed by using a combination of hardware in the processor and a software module. A software module may be located in a mature storage medium in the art, such as a random access memory, a flash memory, a read-only memory, a programmable read-only memory, an electrically erasable programmable memory, a register, or the like. The storage medium is located in the memory, and a processor reads instructions in the memory and completes the steps in the foregoing methods in combination with hardware of the processor. To avoid repetition, details are not described herein again.

In the several embodiments provided in this application, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces, indirect couplings or communication connections between the apparatuses or units, or electrical connections, mechanical connections, or connections in other forms.

The units described as separate parts may or may not be physically separate, and parts displayed as units may or may not be physical units, may be located in one position, or may be distributed on a plurality of network units. A part or all of the units may be selected according to actual needs to achieve the objectives of the solutions of the embodiments of the present invention.

When the integrated unit is implemented in the form of a software functional unit and sold or used as an independent product, the integrated unit may be stored in a computer-readable storage medium. Based on such an understanding, the technical solutions of the present invention essentially, or the part contributing to the prior art, or all or a part of the technical solutions may be implemented in the form of a software product. The software product is stored in a storage medium and includes several instructions for instructing a computer device (which may be a personal computer, a server, or a network device) to perform all or a part of the steps of the methods described in the embodiments of the present invention. The foregoing storage medium includes any medium that can store program code, such as a USB flash drive, a removable hard disk, a read-only memory (English: read-only memory, ROM for short), a random access memory (random access memory, RAM for short), a magnetic disk, or an optical disc.

The foregoing descriptions are merely specific embodiments of the present invention, but are not intended to limit the protection scope of the present invention. Any modification or replacement readily figured out by a person skilled in the art within the technical scope disclosed in the present invention shall fall within the protection scope of the present invention. Therefore, the protection scope of the present invention shall be subject to the protection scope of the claims.

1. A method for performing light processing on a surface of a housing, comprising:
emitting, by a laser engraving machine, a first beam and a second beam;
transmitting, by the laser engraving machine, the first beam to a first bonding surface of the housing using a first light transmission region of a photomask to perform laser engraving on the first bonding surface;
transmitting, by the laser engraving machine, the second beam to a reflector using a second light transmission region of the photomask; and
reflecting, by the reflector, the second beam to a second bonding surface of the housing to perform the laser engraving on the second bonding surface, an angle comprising between the first bonding surface and the second bonding surface.

2. The method of claim 1, wherein the reflector comprises a first reflection sheet and a second reflection sheet, and reflecting the second beam to the second bonding surface of the housing comprising:
reflecting, by the first reflection sheet, the second beam to the second reflection sheet; and
reflecting, by the second reflection sheet, the second beam to the second bonding surface.

3. The method of claim 2, wherein an angle between the first reflection sheet and a vertical direction comprises a range of 15° to 45°.

4. The method of claim 1, wherein the photomask comprises N rows of light transmission holes in a direction parallel to an intersection line of the first bonding surface and the second bonding surface, the second light transmission region comprising light transmission holes located in first n rows, the first light transmission region comprising light transmission holes located in the other (N−n) rows, the N comprising an integer greater than or equal to two, and the n comprising integer greater than or equal to one.

5. The method claim 1, wherein the photomask comprises N rows of light transmission holes that in a direction perpendicular to an intersection line of the first bonding surface and the second bonding surface, the second light transmission region comprising n rows of light transmission holes, the first light transmission region, comprising (N−n) rows of light transmission holes, the N comprising an integer greater than or equal to two, and the n comprising an integer greater than or equal to one.

6. The method of claim 1, wherein the first light transmission region comprises at least one light transmission hole whose aperture comprises a range of 0.1 micrometers (μm) to 3 millimeters (mm).

7. The method of claim 1, wherein the first light transmission region comprises at least one light transmission hole whose surface shape comprises a circle, a triangle, a square, or a parallelogram, or the second light transmission region comprising at least one light transmission hole whose surface shape comprises a circle, a triangle, a square, or a parallelogram.

8. The method of claim 1, wherein the housing comprises a surface housing of a terminal device.

9. An apparatus for performing light processing on a surface of a housing, comprising:
a photomask, comprising:
a first light transmission region configured to transmit a first beam from a laser engraving machine to a first bonding surface of the housing to perform laser engraving on the first bonding surface; and
a second light transmission region configured to transmit a second beam from the laser engraving machine to a reflector, and
the reflector being located below the photomask and configured to reflect the second beam to a second bonding surface of the housing, to perform the laser engraving on the second bonding surface, and an angle comprising between the first bonding surface and the second bonding surface.

10. The apparatus of claim 9, wherein the reflector comprises a first reflection sheet and a second reflection sheet, the first reflection sheet being configured to reflect the second beam to the second reflection sheet, and the second reflection sheet being configured to reflect the second beam from the first reflection sheet to the second bonding surface.

11. The apparatus of claim 10, wherein an angle between the first reflection sheet and a vertical direction comprises a range of 15° to 45°.

12. The apparatus of claim 9, wherein the photomask further comprises N rows of light transmission holes in a direction parallel to an intersection line of the first bonding surface and the second bonding surface, the second light transmission region comprising light transmission holes located in first n rows, the first light transmission region comprising light transmission holes located in the other (N−n) rows, the N comprising an integer greater than or equal to two, and the n comprising an integer greater than or equal to one.

13. The apparatus of claim 9, wherein the photomask further comprises N rows of light transmission holes in a direction perpendicular to an intersection line of the first bonding surface and the second bonding surface, the second light transmission region comprising n rows of light transmission holes, the first light transmission region comprising (N−n) rows of light transmission holes, the N comprising an integer greater than or equal to two, and the n comprising an integer greater than or equal to one.

14. The apparatus of claim 9, wherein the first light transmission region comprises at least one light transmission hole whose aperture comprises a range of 0.1 micrometers (μm) to 3 millimeters (mm).

15. The apparatus of claim 9, wherein the first light transmission region comprises at least one light transmission hole whose surface shape comprises a circle, a triangle, a square, or a parallelogram, or the second light transmission region comprising at least one light transmission hole whose surface shape comprises a circle, a triangle, a square, or a parallelogram.

16. The apparatus of claim 9, wherein the housing comprises a surface housing of a terminal device.

17. The method of claim 2, wherein an angle between the second reflection sheet and the first reflection sheet comprises a range of 125° to 145°.

18. The method of claim 1, wherein the second light transmission region comprises at least one light transmission hole whose aperture comprises a range of 0.1 micrometers (μm) to 3 millimeters (mm).

19. The apparatus of claim 10, wherein an angle between the second reflection sheet and the first reflection sheet comprises a range of 125° to 145°.

20. The apparatus of claim 9, wherein the second light transmission region comprises at least one light transmission hole whose aperture comprises a range of 0.1 micrometers (μm) to 3 millimeters (mm).
